(19) United States
(12) Patent Application Publication
(10) Pub. No.: US 2021/0024361 A1
(43) Pub. Date: Jan. 28, 2021

(54) PRODUCTION OF LITHIUM HEXAFLUOROPHOSPHATE

(71) Applicant: The South African Nuclear Energy Corporation SOC Limited, Madibeng Municipality (ZA)

(72) Inventors: Mpho Diphago Stanley LEKGOATHI, Pretoria (ZA); Johannes Petrus LE ROUX, Madibeng Municipality (ZA); Danny Sello MMOTONG, Madibeng Municipality (ZA)

(73) Assignee: The South African Nuclear Energy Corporation SOC Limited, Madibeng Municipality (ZA)

(21) Appl. No.: 17/042,160

(22) PCT Filed: Mar. 29, 2019
(86) PCT No.: PCT/IB2019/052587

§ 371 Date: Sep. 27, 2020

(30) Foreign Application Priority Data
Mar. 29, 2018 (NL) 2020683

(51) Int. Cl. C01D 15/00; H01M 6/16

(52) U.S. Cl. CPC C01D 15/005; H01M 6/166

(57) ABSTRACT

A method of producing solid lithium hexafluorophosphate (LiPF₆) includes reacting lithium fluoride (LiF) in solid form with gaseous phosphorous pentafluoride (PF₅) in a liquid perhalogenated organic compound that is non-reactive with, i.e. is inert to, the PF₅, thereby producing LiPF₆ in solid form.

### FIELD OF THE INVENTION

THIS INVENTION relates to the production of lithium hexafluorophosphate. The invention provides a method of producing lithium hexafluorophosphate and extends to lithium hexafluorophosphate produced in accordance with the method. The invention also extends to a method of producing an electrolyte and extends to an electrolyte produced in accordance with the method. The invention also provides an electric battery and a method of manufacturing an electric battery.

### BACKGROUND TO THE INVENTION

IT IS KNOWN to use lithium hexafluorophosphate (LiPF₆) as an electrolyte in lithium ion batteries.

Conventional preparation methods of LiPF₆ include wet chemical synthesis methods in aqueous reaction conditions and dry synthesis methods in non-aqueous conditions.

A common method of preparing LiPF₆ using a wet chemical preparation method involves synthesizing water stable organic complexes such as pyridinium or tetraacetonitrilolithium hexafluorophosphate, and converting the complexes into solvated LiPF₆. The pyridinium cation is preferred to the acetonitrile cation as the latter poorly dissolves the lithium base used in a subsequent reaction to substitute the organic cation. However, tetraacetonitrilolithium hexafluorophosphate complex produced by a reaction of LiF salt and PF₅ gas in the presence of acetonitrile allows low temperature decomposition of the complex in vacuum (20° C.) to produce high purity LiPF₆.

Various phosphorus halides and a solution of pyridinium poly (hydrogen fluoride) has been used to synthesize the pyridinium hexafluorophosphate complex, and further reacted the complex with alkali metal hydroxides to obtain their corresponding hexafluorophosphate complexes. Although several alkali-PF₆ salts are stable in sulphuric acid, LiPF₆ is very unstable and cannot be isolated due to the presence of water in the intermediate products. Reaction Equations 1.1 and 1.2 show the chemical reactions involved during the formation of the hexafluorophosphate complex:

PZX₃+C₅H₅NH⁺F(HF)ₙ_{^{−}}→C₅H₅NH⁺PF₆_{^{−}}+H₂Z+3HX (Eq. A)

PX₅+C₅H₅NH₊F(HF)ₙ_{^{−}}C₅H₅NH⁺PF₆_{^{−}}+5HX (Eq. B)

where
Z is oxygen or sulphur; and
X is chlorine or bromine.

It is also known that hexafluorophosphate complexes of ammonia and alkali metals can be prepared by reacting ammonium or alkali metal fluorides with phosphorus pentachloride, however, the subsequent isolation process is tedious and time consuming as the yields are very low.

Another preparation method of LiPF₆ using wet chemical synthesis involves reacting hexafluorophosphoric acid with pyridine to form the complex, and then exchanging the pyridinium cation with a lithium cation from a hydroxide or alkoxide to obtain a LiPF₆ pyridine complex which can be treated further to produce high purity LiPF₆. This is illustrated in Equations 1.3 and 1.4:

HPF₆+C₅H₅N→C₅H₅NPF₆ (Eq. C)

C₅H₅NHPF₆+LiOH+CH₃OH→LiPF_{6.}C₅H₅N (Eq. D)

The lithium base used in this method is dissolved in an alcohol media to avoid a subsequent reaction between the synthesized LiPF₆ and water. This method is based on the fact that alkali metal ions from corresponding hydroxides are easily exchanged with the pyridinium cation. The pyridinium hexafluorophosphate yield is approximately 70%, and a further 96% LiPF₆ crystalline product is obtained from a subsequent reaction of the complex with a lithium base and drying the product in a partial vacuum at 30° C.

Hexafluorophosphoric acid may also be reacted with lithium hydroxide in water to form LiPF₆, however, the formed electrolyte quickly hydrolyzes and precipitate in the form of various other species such as PO₂F₂, PO₄³⁻, and HPO₃F⁻. Another disadvantage associated with this preparation method includes the use of hexafluorophosphoric acid which is a mixture of several weak acids resulting from gradual decomposition of the HPF₆ itself. Therefore, the amount of PF₆_{^{−}} ion available to react is not always known. This requires that a preliminary titration be undertaken between the acid and an alkali hydroxide to determine the exact stoichiometry of the PF₆ ion in the acid before neutralization with pyridine.

Other wet chemical synthesis methods involve the reactions of lithium sources and hexafluorophosphate salts in various solvents. The reaction of LiH with NH₄PF₆ in dimethoxyethane (DME) is one such an example as shown in Equation 1.5:

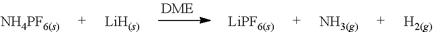

In this chemical process, an ether with at least two functionalities and enough spacing to complex a lithium ligand, for example, 1,2-dimethoxyethane is used to dissolve the ammonium hexafluorophosphate salt. The complex 2DME.LiPF₆, ammonia and hydrogen gas are formed as products. The complex is stable and is further dissolved in an electrolyte solvent for applications in batteries, however, the ether is difficult to remove and will feature in the final electrolyte.

To eliminate the ether interference, the reaction between a lithium source, for example LiH, and NH₄PF₆ can be carried out directly in a solvent to be used in the final electrolyte. At least one of the reactants must be soluble and the other should be insoluble in the solvent used so that excess salts can be easily removed via precipitation from the electrolyte. If a two solvent process is carried out, then the initial solvent used must be non-protic, have high solubility for the lithium compound used and possess a low boiling point. A more viscous, high boiling point solvent, such as ethylene carbonate (EC), can then be added as a co-solvent followed by the evaporation of the initial solvent.

Lithium hexafluorophosphate may also be synthesized using LiF and PCl₅ in water, however, low yields are obtained with this preparation method. To improve on the yield, a chloride salt such as LiCl or even LiF is dissolved in anhydrous HF, and then PCl₅ is slowly added to precipitate a lithium hexafluorophosphate salt with a higher yield.

A further method of preparing LiPF₆ involves using PCl₃ and HF in an anhydrous organic solvent of the type carbonic ethers and esters. The carbonates such as ethyl carbonate and other related solvents react and form adducts with PF₅ gas. Not only is the reaction of PF₅ and the solvent a challenge when this preparation method is used, but the introduction of HF is not desirable as it will further react and introduce additional complications.

In light of the above, the following shortcomings associated with using wet chemical synthesis methods for the preparation of LiPF₆ salt have been identified:
(i) The Li+ ion is too small to precipitate with a relatively larger PF₆_{^{−}} ion; hence obtaining LiPF₆ crystals directly from the solution is difficult.
(ii) The LiPF₆ salt itself is thermally unstable and will decompose during thermal treatment to remove the solvent used.

A widely used method for the synthesis of LiPF₆ using non-aqueous conditions involves a reaction between LiF and PF₅ gas to form LiPF₆. Various drawbacks are associated with this method, including the difficulty of handling poisonous PF₅ gas and low product purity (90-95%) compared to the required purity of at least 99.9% of LiPF₆ used in battery applications. Excess LiF and LiHF₂ are also formed as by-products in this preparation method.

This technique has been modified to improve the purity of the LiPF₆ product by reacting acetonitrile with the obtained LiPF₆ to form tetraacetonitrilolithium hexafluorophosphate, which, upon partial heating in vacuum, regenerates a purer LiPF₆ salt.

The LiPF₆ salt may also be synthesized by reacting lithium fluoride and bromine trifluoride in excess phosphorous pentoxide. Other methods for LiPF₆ synthesis involve in situ generation of PF₅ gas and its subsequent reaction with a lithium source to form the LiPF₆ salt. This technique is said to eliminate moisture ingress into the intermediates during the chemical reaction.

Solid state thermal reactions provide alternative dry synthesis methods to the gaseous routes for the preparation of LiPF₆. A lithium source, for an example, may be reacted with a phosphate such as ammonium phosphate at a high temperature (300° C.) in a solid state to form lithium metaphosphate, which is then further reacted with ammonium fluoride at 150° C. to obtain LiPF₆. This is shown in Equations 1.6 and 1.7 below:

(NH₄)₂HPO₄+Li₂O→2LiPO₃+4NH₃+3H₂₀ (Eq. F)

LiPO₃+6NH₄F→LiPF₆+6NH₃+3H₂O (Eq. G)

Solid state thermal reactions tend to be incomplete if powders are mixed as received and heated at elevated temperatures. This, therefore, presents a challenge to thoroughly grind the reactants together and press them into pellets to facilitate contact between them. Despite the high temperature and pressures needed to facilitate solid state reactions, these types of chemical reactions are still the preferred reaction methods for producing advanced, highly ordered crystal structures such as special ceramics, piezoelectrics and some scintillation crystals, hence the technique may be used to produce highly crystalline LiPF₆.

The quest for water free and pure LiPF₆ electrolyte salt has also prompted the use of fluorine gas at room temperature to make the salt. In contrast to using anhydrous hydrogen fluoride as a solvent during fluorination of LiF by PF₅ gas, the use of pure fluorine does not produce oxyfluorides of the form LiPOₓF_{y} as impurities. These oxyfluorides are partially dissolved in HF and therefore remain as impurities in the final product.

It has been shown that LiPF₆ can be produced by reacting phosphorus with fluorine gas at a temperature of 23° C. to generate PF₅ gas, which, is then reacted in situ with LiF to produce LiPF₆. The fluorine gas is first liquefied at −196° C. using liquid nitrogen, and then the temperature is increased stepwise to −80° C., where the reaction commenced. The reaction is allowed to occur slowly until a temperature of 23° C. where the LiPF₆ production rate is high. The temperature is further elevated to 150° C. to obtain a purer product. This technique is time consuming, and the reaction is expected to be completed after 10 hr, which is expensive in terms of production time.

It is an object of the invention to at least alleviate the drawbacks mentioned above, and particularly to minimize and more preferably to avoid completely the formation of HF.

### SUMMARY OF THE INVENTION

IN ACCORDANCE WITH A FIRST ASPECT OF THE INVENTION IS PROVIDED a method of producing lithium hexafluorophosphate (LiPF₆), the method including reacting lithium fluoride (LiF) with phosphorous pentafluoride (PF₅) in a liquid medium that comprises a perhalogenated organic compound that is non-reactive with, i.e. is inert to, the PF₅ and is a solvent for the PF₅, thereby producing LiPF₆ in solid, e.g. granular, form.

The reaction is therefore performed in the liquid medium.

As stated, the LiPF₆ is produced in the liquid medium in solid form. It follows that the liquid medium is not a solvent for LiPF₆ in solid form.

The liquid medium may be provided by the perhalogenated organic compound, with the perhalogenated organic compound thus being a liquid perhalogenated organic compound. Typically, the liquid medium would therefore consist of the perhalogenated organic compound.

Mixtures of two or more perhalogenated organic compounds may be employed as or comprised by the liquid medium. Such mixtures are included within the scope of the invention, and in a broad sense the term perhalogenated organic compound therefore includes mixtures of two or more perhalogenated organic compounds.

The halogen of the perhalogenated organic compound may, in particular, be fluorine.

In this specification “perhalogenated” means, as is conventionally understood in the art of the invention, a fully halogenated version of an organic compound, in that all of the hydrogen atoms of the organic compound have been substituted with halogen atoms, thus providing the perhalogenated organic compound. For example, for the organic compound decalin (C₁₀H₁₈), the corresponding perhalogenated organic compound is perfluorodecalin (C₁₀F₁₈).

However, the above meaning of “perhalogenated” does not exclude
that the perhalogenated organic compound may be a virtually fully halogenated version of the organic compound, in which case the perhalogenated organic compound may still include some hydrogen atoms; and/or
that the perhalogenated organic compound is not a saturated organic compound, e.g. that it is an alkene or an alkyne,
   and the meaning afforded to “perhalogenated” in this specification is therefore broader in scope than the conventional meaning, although the narrower meaning is preferred in the context of the invention.

In any event, in the context of the invention the extent of halogenation of the organic compound, as embodied in the perhalogenated organic compound, is such that the perhalogenated organic compound is inert to the PF₅, i.e. is non-reactive with the PF₅, and is a solvent for the PF₅.

The LiF may be in solid, e.g. granular, form. Thus, the liquid medium would not be a solvent for LiF in solid form.

The PF₅ may be gaseous PF₅.

Reacting the LiF with gaseous PF₅ may therefore include
providing the LiF in the liquid medium, e.g. by dispersing it in the liquid medium when the LiF is in solid form; and
dissolving PF₅ in the liquid medium containing the LiF, e.g. by contacting the liquid medium with gaseous PF₅.

It will be appreciated that reacting the LiF in solid form with gaseous PF₅ therefore does not necessarily include directly contacting the LiF in solid form with gaseous PF₅. Instead, reacting the LiF in solid form with gaseous PF₅ would include contacting the liquid medium that contains the LiF in solid form with gaseous PF₅.

As stated, the perhalogenated organic compound is inert to the PF₅. In other words, the perhalogenated organic compound is non-reactive with the PF₅ in the sense that the PF₅ does not chemically react with the perhalogenated organic compound to form a new compound.

In one embodiment of the invention, the perhalogenated organic compound may be a perhalogenated alkane. For example, the perhalogenated alkane may be a cyclic or non-cyclic perfluorocarbon, preferably of the formula CₓF_{y} where x is an integer selected from 1 to 10 and y is an integer selected from 4 to 20, such as perfluorodecalin or perfluoroheptane or a non-cyclic perfluorocarbon selected from C₁F₄ and C₆F₁₄ to C₉F₂₀.

In another embodiment of the invention, the perhalogenated organic compound may be a perfluoroalkene. For example, the perfluoroalkene may be a perfluoroaromatic compound such as hexafluorobenzene or a perfluoroaromatic compound selected from C₆F₆ to C₁₀F₈, or tetrafluoroethylene or a perfluoroalkene selected from C₃F₆ or C₄F₈.

It is envisaged that the perhalogenated organic compound may further be an ether, and particularly a perfluoroalkene ether. A typical generic formula may be R—O—R′.

Thus, the perhalogenated organic compound may in one embodiment be a perfluorocarbon. The perfluorocarbon may be selected from cyclic and non-cyclic perfluoroalkanes, and cyclic and non-cyclic perfluoroalkenes, and mixtures of any two or more thereof, severally or jointly. In other words, it may be selected from mixtures of two or more cyclic perfluoroalkanes, mixtures of two or more non-cyclic perfluoroalkanes, mixtures of two or more cyclic perfluoroalkenes, mixtures of two or more non-cyclic perfluoroalkenes, and mixtures of two more of cyclic perfluoroalkanes, non-cyclic perfluoroalkanes, cyclic perfluoroalkenes, and non-cyclic perfluoroalkenes In particular, the perfluorocarbon may be selected from perfluorodecalin, perfluoroheptane, hexafluorobenzene, tetrafluoroethylene, and mixtures of any two or more thereof.

As has been mentioned, with the LiF being in solid form and with the liquid medium not being a solvent for LiPF₆, the produced LiPF₆ would also be in solid form. Thus, the reaction between the LiF and the PF₅ would convert the LiF in solid form into LiPF₆ in solid form.

The method may in some cases produce a mixture of LiPF₆ in solid form and unreacted LiF in solid form, contained in the liquid medium.

The method may include recovering LiPF₆ in solid form and any unreacted LiF in solid form from the liquid medium, e.g. by physical separation such as by filtration.

After recovering LiPF₆ in solid form and any unreacted LiF in solid form, the method may include dissolving the LiPF₆ in solid form in a solvent for LiPF₆, thus producing a solution of LiPF₆.

Producing the solution of LiPF₆ may be particularly, but not exclusively, applicable when the method produces the mixture of LiPF₆ in solid form and unreacted LiF in solid form as hereinbefore described, to recover LiPF₆ from the mixture of LiPF₆ in solid form and unreacted LiF in solid form. Thus, the method may include treating the mixture of LiPF₆ in solid form and unreacted LiF in solid form with a solvent for LiPF₆ in solid form. It will be appreciated in this regard that the solvent for LiPF₆ in solid form would not be a solvent for LiF in solid form.

The solvent for LiPF₆ in solid form may be an electrolyte solvent, suitable for use in an electric battery, particularly a lithium-ion battery. For example, the solvent may be selected from ethylene carbonate, propylene carbonate, dimethyl carbonate, dimethyl ether, and mixtures thereof.

Naturally, temperature and pressure conditions for the reaction would be selected such that the perhalogenated organic compound would be in the liquid phase. It is noted that higher pressure conditions would favour the conversion of LiF into LiPF₆.

The method is preferably effected in the absence of other reactants, e.g. hydrochloric acid.

The reaction may be carried out at a pressure in a range of from 0 kPa to 3 000 kPa.

The temperature at which the reaction would be carried out would be such that the stated phase conditions of the various components would prevail for the purpose of the reaction.

THE INVENTION EXTENDS, AS A SECOND ASPECT THEREOF, to LiPF₆ produced in accordance with the method of the invention as hereinbefore described, in solid form.

IN ACCORDANCE WITH A THIRD ASPECT OF THE INVENTION IS PROVIDED a method of producing an electrolyte, the method including
producing LiPF₆ in solid form in accordance with the method of the first aspect of the invention; and
dissolving the LiPF₆ in solid form in a solvent for LiPF₆.

The solvent for LiPF₆ in solid form may be an electrolyte solvent, suitable for use in an electric battery. For example, the solvent may be selected from ethylene carbonate, propylene carbonate, dimethyl carbonate, dimethyl ether, and mixtures thereof.

THE INVENTION EXTENDS, AS A FOURTH ASPECT THEREOF, to an electrolyte produced in accordance with the method of the third aspect of the invention.

The electrolyte may be an electrolyte for an electric battery, particularly a lithium-ion battery.

IN ACCORDANCE WITH A FIFTH ASPECT OF THE INVENTION IS PROVIDED an electric battery including an electrolyte produced using LiPF₆ produced in accordance with the method of the first aspect of the invention.

The electrolyte may be an electrolyte produced in accordance with the method of the third aspect of the invention.

The electric battery may be a lithium-ion battery.

IN ACCORDANCE WITH A SIXTH ASPECT OF THE INVENTION IS PROVIDED a method of manufacturing an electric battery, the method including
producing an electrolyte in accordance with the method of the third aspect of the invention; and
including the electrolyte in an electric battery.

The electric battery may be a lithium-ion battery

### EXAMPLES

EMBODIMENTS OF THE INVENTION will now be described by way of example only, with reference to the following examples.

### Example 1: Reaction between LiF and PF₅ Gas in the Presence of a Cyclic or Polycyclic Perfluorocarbon Solvent

A clean, thick-walled stainless-steel reactor capable of handling more than 10 bar of gas pressure was loaded with 2 g of LiF solid powder purchased from Sigma-Aldrich or Alpha-Aesar.

60 ml liquid perfluorodecalin was added into the reactor, with the LiF thus becoming suspended in the perfluorodecalin.

The reactor was then sealed in a glovebox and connected to a system consisting of a vacuum line, a high-pressure indicator and a high-pressure PF₅ gas cylinder.

PF₅ gas was introduced from its feed cylinder into the reactor, thus contacting the suspension of LiF in perfluorodecalin.

PF₅ feeding into the reactor continued until the equilibrium was achieved, which was maintained (increase in PF₅ gas pressure maintained at 7 bar).

The reaction was allowed to digest for at least 1 day.

Excess PF₅ gas was removed from the reactor by cycle purging and then applying vacuum.

The reactor was then transferred to a nitrogen glove box for opening in a dry, inert environment.

An off-white dense liquid with gel on the reactor sides was recovered and filtered.

The retentate was dried using nitrogen in a glovebox and a mixture of unreacted LiF and formed LiPF₆, which was previously in suspension in the liquid medium, was recovered in solid form.

The reaction that took place is in accordance with reaction equation 1:

LiF(s)+PF₅(g)→LiPF₆(s) (Eq. 1)

LiPF₆ was recovered from the mixture of LiPF₆ and unreacted LiF using a solvent for LiPF₆. Conversion of LiF in excess of 90% have been observed, with LiPF₆ recovery of up to 99%.

Suitable solvents include ethylene carbonate, propylene carbonate, dimethyl carbonate, dimethyl ether, or combinations thereof.

### Example 2: A Reaction between LiF and PF₅ Gas in the Presence of Non-Cyclic or Branched Perfluorocarbon Solvent

LiF in solid form is dispersed in liquid perfluoroheptane or any non-cyclic perfluorocarbons of range C₁F₄, and C₆F₁₄ to C₉F₂₀ liquid.

The reaction that takes place is in accordance with reaction equation 1.

The reaction temperature range is −94° C. to 127° C.

The reaction pressure range is 0 kPa to 3 000 kPa, more preferably up to 1000 kPa.

Up to 99% recovery of LiPF₆ may be achieved when produced LiPF₆ is dissolved in a solvent for LiPF₆ in solid form, which solvent comprises ethylene carbonate, propylene carbonate, dimethyl carbonate, dimethyl ether, or any combination thereof.

### Example 3: A Reaction between LiF and PF₅ Gas in the Presence of Perfluoroaromatic Solvent

LiF in solid form is dispersed in liquid hexafluorobenzene or a perfluoroaromatic liquid compound in the range C₆F₆ to C₁₀F₈.

The reaction that takes place is in accordance with reaction equation 1.

The reaction temperature range is 5° C. to 100° C.

The reaction pressure range is 0 kPa to 3 000 kPa, more preferably up to 1000 kPa.

Up to 99% recovery of LiPF₆ may be achieved when produced LiPF₆ is dissolved in a solvent for LiPF₆ in solid form, which solvent comprises ethylene carbonate, propylene carbonate, dimethyl carbonate, dimethyl ether, or any combination thereof.

### Example 4: A Reaction between LiF and PF₅ Gas in the Presence of Fluoroalkene Solvent

LiF in solid form is dispersed in liquid tetrafluoroethylene solvent (C₂F₄) or a liquid fluoroalkene compound selected from C₃F₆ or C₄F₈.

The reaction that takes place is in accordance with reaction equation 1.

The reaction temperature range is −94° C. to 100° C.

The reaction pressure range is 0 kPa to 3 000 kPa, more preferably up to 1000 kPa.

Up to 99% recovery of LiPF₆ may be achieved when produced LiPF₆ is dissolved in a solvent for LiPF₆ in solid form, which solvent comprises ethylene carbonate, propylene carbonate, dimethyl carbonate, dimethyl ether, or any combination thereof.

### Discussion

THE METHOD OF THE FIRST ASPECT OF THE INVENTION uses an inert, non-corrosive, non-poisonous liquid medium for the reaction of LiF and PF₅ instead of corrosive HF which is the preferred liquid medium for this reaction in the art of the invention.

Thus, the inventors have eliminated the need to remove the HF from the product through tiresome purification processes such as vacuum distillation.

Furthermore, HF is known to be corrosive and reactive inside a battery, which makes its avoidance for use as a liquid medium all the more desirable.

Some advantages associated with the liquid media exploited by the method of the invention are the following:
it is inert in relation to PF₅ gas;
it is inert in relation to the product LiPF₆;
it is often not poisonous;
it dissolves the PF₅ gas, making it readily accessible to the lithium fluoride without mass transfer limitations;
no azeotropic formation of PF₅ gas with the solvent is experienced, which tends to compete with lithium fluoride for PF₅ gas in traditional HF involved processes; and
the liquid media are non-corrosive.

Thus, the inventors have provided an attractive, utile and sustainable alternative for the production of LiPF₆ which is particularly advantageous over prior art processes, some of which have been discussed herein.

1. A method of producing lithium hexafluorophosphate (LiPF₆) in solid form, the method including reacting lithium fluoride (LiF) in solid form with gaseous phosphorous pentafluoride (PF₅), wherein the reaction is performed in a liquid perhalogenated organic compound that is inert to the PF₅ and is a solvent for the PF₅, thereby producing LiPF₆ in solid form.

2. The method according to claim 1, wherein reacting the LiF with gaseous PF₅ includes
dispersing the LiF in solid form in the liquid medium; and
dissolving gaseous PF₅ in the liquid medium containing the LiF in solid form.

3. The method according to claim 1, wherein the perhalogenated organic compound is a perfluorocarbon.

4. The method according to claim 3, wherein the perfluorocarbon is selected from cyclic and non-cyclic perfluoroalkanes, and cyclic and non-cyclic perfluoroalkenes, and mixtures of any two or more thereof, severally or jointly.

5. The method according to claim 1, wherein the perfluorocarbon is selected from perfluorodecalin, perfluoroheptane, hexafluorobenzene, tetrafluoroethylene, and mixtures of any two or more thereof.

6. (canceled)

7. A method of producing an electrolyte, the method including
producing LiPF₆ in solid form according to the method of claim 1; and
dissolving the LiPF₆ in solid form in a solvent for LiPF₆.

8. The method according to claim 7, wherein the solvent for LiPF₆ is selected from ethylene carbonate, propylene carbonate, dimethyl carbonate, dimethyl ether, and mixtures thereof.

9. (canceled)

10. A method of manufacturing an electric battery, the method including
producing an electrolyte according to the method of claim 7; and
including the electrolyte in an electric battery.
